(19) United States
(12) Patent Application Publication
(10) Pub. No.: US 2006/0134441 A1
(43) Pub. Date: Jun. 22, 2006

(54) Siloxane-based polymer and method for forming dielectric film using the polymer

(75) Inventors: Sang Kook Mah, Seoul (KR); Hyeon Jin Shin, Suwon-Si (KR); Hyun Dam Jeong, Suwon-Si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG CORNING CO., LTD., Suwon-si (KR)

(21) Appl. No.: 11/304,628

(22) Filed: Dec. 16, 2005

(30) Foreign Application Priority Data
Dec. 16, 2004 (KR) 2004-107010

(51) Int. Cl. B32B 9/04; B05D 3/02; C08G 77/04

(52) U.S. Cl. 428/447; 427/387; 528/34

(57) ABSTRACT

A siloxane-based polymer having superior mechanical properties and low dielectric properties and a method for forming a dielectric film using the polymer. The siloxane-based polymer not only has superior mechanical properties, but also exhibits low hygroscopicity and good compatibility with pore-forming materials, which leads to a low dielectric constant. In addition, since the siloxane-based polymer is highly compatible with pore-forming materials and has improved applicability to semiconductor processes, it may be advantageously used as a material for dielectric films of semiconductor devices.

### BACKGROUND OF THE INVENTION

This non-provisional application claims priority under 35 U.S.C. § 119(a) on Korean Patent Application No. 2004-107010 filed on Dec. 16, 2004, which is herein incorporated by reference.

1. Field of the Invention

Embodiments of the present invention relate to a novel siloxane-based polymer and a method for forming a dielectric film using the polymer. More specifically, embodiments of the present invention relate to a siloxane-based polymer having superior mechanical properties and low dielectric properties, and a method for forming a dielectric film using the polymer.

2. Description of the Related Art

In recent years, as the degree of integration in semiconductor devices has increased, the transmission of electric signals has slowed due to an increase in RC delay between interconnections. For this reason, there is a growing interest in lowering the capacitance of interlayer insulating thin films in semiconductor devices. For example, U.S. Pat. Nos. 3,615,272, 4,399,266, 4,756,977 and 4,999,397 disclose polysilsesquioxane dielectric films having a dielectric constant of about 2.5-3.1 which can be formed by spin-on-deposition (SOD). The polysilsesquioxane dielectric films can replace conventional SiO₂ dielectric films (dielectric constant=about 4.0) formed by chemical vapor deposition (CVD). On the other hand, hydrogen silsesquioxanes and a number of preparation processes thereof are well known in the art. For example, U.S. Pat. No. 3,615,272 teaches a process for preparing a completely condensed hydrogen silsesquioxane by condensing trichloro-, trimethoxy- or triacetoxysilane in a sulfuric acid medium. Further, U.S. Pat. No. 5,010,159 discloses a process for preparing a hydrogen silsesquioxane by hydrolyzing a hydrosilane in an arylsulfonic acid hydrate-containing hydrolysis medium to form a resin, and contacting the resin with a neutralizing agent. Further, U.S. Pat. No. 6,232,424 suggests a highly soluble silicone resin composition having good solution stability which is prepared by hydrolyzing and polycondensing a tetraalkoxysilane, an organosilane and an organotrialkoxysilane in the presence of water and a catalyst. Further, U.S. Pat. No. 6,000,339 discloses a process for preparing a silica-based compound which has improved oxygen plasma resistance and other physical properties, and enables the formation of a thick layer. According to this process, the silica-based compound is prepared by reacting a monomer selected from alkoxysilanes, fluorine-containing alkoxysilanes and alkylalkoxysilanes with an alkoxide of titanium (Ti) or zirconium (Zr) in the presence of water and an appropriate catalyst. Further, U.S. Pat. No. 5,853,808 discloses siloxane and silsesquioxane polymers useful for preparing SiO₂-rich thin films wherein the polymers are prepared from organosilanes having a β-substituted reactive group, and thin film compositions comprising the polymers. Further, European Patent No. 1376671 discloses compositions for preparing low-dielectric constant materials comprising a siloxane or organosiloxane precursor, and a method for forming a dielectric film with a dielectric constant not greater than 3.7 using the precursor. Further, U.S. Pat. No. 5,378,790 discloses organic/inorganic hybrid materials having good physical properties. Korean Patent Laid-open No. 2002-80097 discloses an organosilicate polymer prepared by hydrolyzing and polycondensing a linear organosilane oligomer with another silane compound, and a low-dielectric constant film using the organosilicate polymer.

However, the prior art dielectric thin films formed by using siloxane-based polymers have a problem of a relatively high dielectric constant. Although the dielectric thin films have a sufficiently low dielectric constant, they have poor mechanical properties. Additionally, they have limited applicability to semiconductor processes due to high organic carbon content. In particular, in the case of a polymer prepared from a Si compound having four functional groups, such as tetramethoxysilane or tetraethoxysilane, there is a problem of a high hygroscopicity despite a low organic carbon content and good mechanical properties, causing an increase in dielectric constant. Accordingly, the polymer has limited applicability to dielectric films, particularly dielectric films formed by SOD processes. Meanwhile, in recent years, there has been an increased demand for siloxane-based polymers highly compatible with pore-forming materials (porogens) to be combined so as to have a lower dielectric constant.

Thus, there is a need in the art to develop a material for forming a dielectric film by SOD processes which has a low dielectric constant, superior mechanical properties (e.g., modulus), good compatibility with a pore-forming material, and markedly improved applicability to semiconductor processes.

### OBJECTS AND SUMMARY

The present inventors have earnestly and intensively conducted research to solve the above-mentioned problems. As a result, the present inventors have found that a siloxane-based polymer prepared by the polymerization of at least one linear siloxane compound capable of forming a less hygroscopic ‘T’ structure in which one Si atom of the backbone chain is bonded to three oxygen atoms or by the copolymerization of the linear siloxane compound with a cyclic siloxane compound, exhibits superior low dielectric properties, good mechanical properties (e.g., modulus), is highly compatible with conventional pore-forming materials (porogens), maintains its hygroscopicity at a low level even during SOD processes, thus ensuring good insulating characteristics, and retains a high SiO₂ content, resulting in improved applicability to semiconductor processes. Embodiments of the present invention have been achieved based on this finding.

Therefore, it is one object of embodiments of the present invention to provide a siloxane-based polymer which may be used to form a dielectric film with superior low dielectric properties, mechanical properties and insulating properties.

It is another object of embodiments of the present invention to provide a method for forming a dielectric film using the siloxane-based polymer.

In accordance with one aspect of embodiments of the present invention for achieving the above objects, there is provided a siloxane-based polymer which is prepared by the hydrolysis and polycondensation of a monomer represented by Formula 1 below:

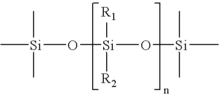

wherein R₁ and R₂ are each independently a hydrogen atom, hydroxy, alkoxy, acetoxy, alkyl, aryl, or O—Si(OR)₃ (in which R is a C₁-C₃ alkyl group); and n is an integer of 2 to 100 (with the proviso that at least one of R₁ and R₂ is a reactive functional group selected from a hydrogen atom, hydroxy, alkoxy, acetoxy, or O—Si(OR)₃),

with at least one monomer selected from compounds represented by Formulae 2 to 5 below:
(R₁)ₙSi(OR₂)₄₋ₙ Formula 2

wherein R₁ is a hydrogen atom, a C₁-C₃ alkyl group, a halogen atom, or a C₆-C₁₅ aryl group; R₂ is a hydrogen atom, a C₁-C₃ alkyl group or a C₆-C₁₅ aryl group, with the proviso that at least one of R₁ and OR₂ is a hydrolysable functional group; and n is an integer of 0 to 3,

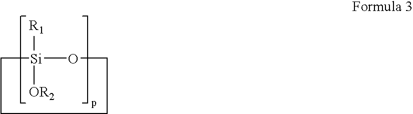

wherein R₁ is a hydrogen atom, a C₁-C₃ alkyl group or a C₆-C₁₅ aryl group; R₂ is a hydrogen atom, a C₁-C₁₀ alkyl group or SiX₁X₂X₃ (in which X₁, X₂ and X₃ are each independently a hydrogen atom, a C₁-C₃ alkyl group, a C₁-C₁₀ alkoxy group, or a halogen atom, with the proviso that at least one of X₁, X₂ and X₃ is a hydrolysable functional group); and p is an integer of 3 to 8,

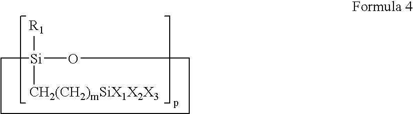

wherein R₁ is a hydrogen atom, a C₁-C₃ alkyl group or a C₆-C₁₅ aryl group; X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; m is an integer of 0 to 10; and p is an integer of 3 to 8,
X₃X₂X₁Si—M—SiX₁X₂X₃ Formula 5

wherein X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; M is a C₁-C₁₀ alkylene group or a C₆-C₁₅ arylene group, hydrolysates thereof, and condensates thereof, in an organic solvent in the presence of water and an acid or base catalyst.

In accordance with another aspect of embodiments of the present invention, there is provided a method for forming a dielectric film using the siloxane-based polymer.

### BRIEF DESCRIPTION OF THE DRAWINGS

The above and other objects, features and other advantages of embodiments of the present invention will be more clearly understood from the following detailed description taken in conjunction with the accompanying drawings, in which:

FIG. 1 is a Si-NMR spectrum of a polymer prepared in Preparative Example 1; and

FIG. 2 is a Si-NMR spectrum of a polymer prepared in Preparative Example 2.

### DETAILED DESCRIPTION OF THE PREFERRED EMBODIMENTS

A siloxane-based polymer of embodiments of the present invention will now be described in more detail.

A siloxane-based resin of embodiments of the present invention is a copolymer prepared by the hydrolysis and polycondensation of a linear siloxane compound capable of forming a ‘T’ structure with one to four other siloxane compounds in an organic solvent in the presence of water and an acid or base catalyst.

The term “linear siloxane compound” as used herein refers to a compound having a structure in which one Si atom is bonded to three oxygen atoms, including reactive functional groups capable of bonding with oxygen through reactions in the backbone rings. Specifically, the linear siloxane compound has a structure of Formula 1 below:

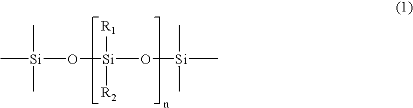

wherein R₁ and R₂ are each independently a hydrogen atom, hydroxy, alkoxy, acetoxy, alkyl, aryl, or O—Si(OR)₃ (in which R is a C₁-C₃ alkyl group); and n is an integer of 2 to 100 (with the proviso that at least one of R₁ and R₂ is a reactive functional group selected from a hydrogen atom, hydroxy, alkoxy, acetoxy, or O—Si(OR)₃).

Since a siloxane-based polymer of embodiments of the present invention may be prepared by using the siloxane compound of Formula 1 having a less hygroscopic ‘T’ structure as a component, it may have a low hygroscopicity, thus achieving a low dielectric constant. In addition, a dielectric film formed using a siloxane-based polymer of embodiments of the present invention may have superior insulating properties and mechanical properties.

Examples of preferred compounds having the structure of Formula 1 include compounds represented by Formulae 6 and 7 below:

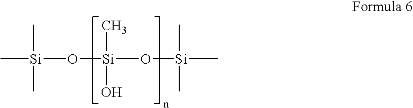

wherein n is an integer of 2 to 100;

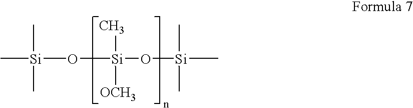

wherein n is an integer of 2 to 100.

A comonomer that is polymerized with the siloxane compound of Formula 1 to prepare a siloxane-based polymer of embodiments of the present invention may be at least one compound selected from compounds represented by Formulae 2 to 5 below:
(R₁)ₙSi(OR₂)₄₋ₙ (2)

wherein R₁ is a hydrogen atom, a C₁-C₃ alkyl group, a halogen atom, or a C₆-C₁₅ aryl group; R₂ is a hydrogen atom, a C₁-C₃ alkyl group or a C₆-C₁₅ aryl group, with the proviso that at least one of R₁ and OR₂ is a hydrolysable functional group; and n is an integer of 0 to 3,

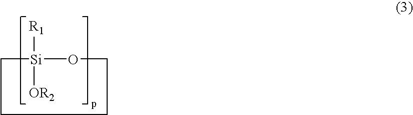

wherein R₁ is a hydrogen atom, a C₁-C₃ alkyl group or a C₆-C₁₅ aryl group; R₂ is a hydrogen atom, a C₁-C₁₀ alkyl group or SiX₁X₂X₃ (in which X₁, X₂ and X₃ are each independently a hydrogen atom, a C₁-C₃ alkyl group, a C₁-C₁₀ alkoxy group, or a halogen atom, with the proviso that at least one of X₁, X₂ and X₃ is a hydrolysable functional group); and p is an integer of 3 to 8,

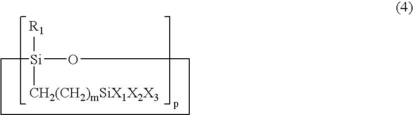

wherein R₁ is a hydrogen atom, a C₁-C₃ alkyl group or a C₆-C₁₅ aryl group; X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; m is an integer of 0 to 10; and p is an integer of 3 to 8,
X₃X₂X₁Si—M—SiX₁X₂X₃ (5)

wherein X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; M is a C₁-C₁₀ alkylene group or a C₆-C₁₅ arylene group, hydrolysates thereof, and condensates thereof.

Preferred compounds of Formulae 2 to 5, hydrolysates thereof, and condensates thereof are those represented by Formulae 8 and 9 below:
SiₐO_{0.5b}(OMe)_{c}(OH)_{d} Formula 8

wherein a is an integer of 2 to 500, 4a=(b+c+d).

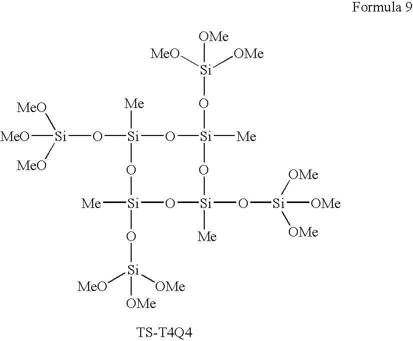

When the compound of Formula 1 (monomer a) is polymerized with at least one compound, as a comonomer, selected from the compounds of Formulae 2 to 5, hydrolysates thereof and condensates thereof to prepare a siloxane-based polymer of embodiments of the present invention, the molar ratio between the monomers is properly determined according to intended characteristics of the dielectric film to be formed, but there are no particular limitations on the molar ratio. For example, when the siloxane compound of Formula 1 is copolymerized with the comonomer, i.e., the compound of Formula 2, the compound of Formula 3, the compound of Formula 4 or the compound of Formula 5, the molar ratio of the siloxane compound to the comonomer is between 0.01:99.99 and 99.99:0.01.

Examples of suitable organic solvents that may be used to prepare a siloxane-based polymer of embodiments of the present invention include, but are not limited to, aliphatic hydrocarbon solvents, such as hexane, heptane, etc.; aromatic hydrocarbon solvents, such as anisole, mesitylene, xylene, etc.; ketone-based solvents, such as methyl isobutyl ketone, 1-methyl-2-pyrrolidinone, cyclohexanone, acetone, etc.; ether-based solvents, such as tetrahydrofuran, isopropyl ether, propylene glycol propyl ether, etc.; acetate-based solvents, such as ethyl acetate, butyl acetate, propylene glycol methyl ether acetate, etc.; alcohol-based solvents, such as isopropyl alcohol, butyl alcohol, etc.; amide-based solvents, such as dimethylacetamide, dimethylformamide, etc.; silicon-based solvents; and mixtures thereof.

Examples of preferred acid catalysts that may be used in embodiments of the present invention include, but are not particularly limited to, hydrochloric acid, nitric acid, benzene sulfonic acid, oxalic acid, formic acid, and mixtures thereof. Examples of preferred base catalysts that may be used in embodiments of the present invention include, but are not particularly limited to, potassium hydroxide, sodium hydroxide, triethylamine, sodium bicarbonate, pyridine, and mixtures thereof. The molar ratio of the total monomers to the catalyst used herein is preferably in the range of 1:1×10⁻⁵ to 1:10. On the other hand, the molar ratio of the total monomers to water is preferably in the range of 1:1 to 1:100. The hydrolysis and the polycondensation may be carried out under appropriate time and temperature conditions, preferably at 0-200° C. for 0.1-100 hours.

A siloxane-based polymer thus prepared preferably has a weight average molecular weight of 3,000 to 300,000 and a Si—OH content of 5% or higher with respect to the total end groups of the polymer.

Embodiments of the present invention also provide a method for forming a dielectric film comprising the steps of i) dissolving the siloxane-based polymer, and if necessary, a pore-forming material (porogen) in an organic solvent to prepare a coating solution, and ii) applying the coating solution to a substrate, followed by heat-curing.

First, the preparation procedure of a coating solution used in the formation of a dielectric film according to embodiments of the present invention will be explained.

Examples of pore-forming materials that may be used to prepare the coating solution include any known pore-forming materials that may be used to form porous dielectric films. Examples of preferred pore-forming materials include cyclodextrins, polycaprolactones, Brij surfactants, polyethylene glycol-polypropylene glycol-polyethylene glycol triblock copolymer surfactants, and derivatives thereof. These compounds may be used alone or as a mixture of two or more thereof. The pore-forming material is preferably present in an amount of 0% to 70% by weight, based on the total weight of the solid matters (i.e., the siloxane-based polymer and the pore-forming material) of the coating solution, but is not limited to this range.

Examples of preferred organic solvents that may be used to prepare the coating solution include, but are not particularly limited to, all organic solvents used for the preparation of the siloxane-based polymer. The solid content of the coating solution is preferably in the range of 5-70% by weight, based on the total weight of the composition, but is not particularly limited to this range.

Thereafter, the coating solution may be applied to a substrate, and heat-cured to form a dielectric film of embodiments of the present invention.

Various substrates may be used to form a dielectric film of embodiments of the present invention so far as the objects of embodiments of the present invention are not impaired. As the substrate, any substrate capable of withstanding the heat-curing conditions may be used in embodiments of the present invention. Glass substrates, silicon wafers, and plastic substrates may be used according to the intended application. In embodiments of the present invention, the application of the coating solution may be carried out by spin coating, dip coating, spray coating, flow coating, and screen printing techniques, but embodiments of the present invention are not especially limited to these coating techniques. In view of ease of application and thickness uniformity, spin coating is most preferred. Upon spin coating, the coating speed is preferably adjusted within 800-5,000 rpm.

Optionally, a method of embodiments of the present invention may further comprise the step of evaporating the organic solvent to dry the film after application of the coating solution. The film drying may be conducted by exposing the film to the atmosphere, subjecting the film to a vacuum in the initial stage of the heat-curing step, or mildly heating the film to a temperature of preferably 200° C. or lower.

In step ii), the film is heat-cured at a temperature of 150-600° C. and preferably 200-450° C. for 1-180 minutes to form a preferably crack-free insoluble coating film. The term “crack-free thin film” as used herein is defined as a coating film free of cracks when observed by an optical microscope with a magnification of 1,000×. As used herein, the term “insoluble coating film” refers to a coating film substantially insoluble in solvents used to deposit the siloxane-based polymer or solvents known to be useful in applying a resin to a substrate. When the coating solution contains a pore-forming material, the heat-curing temperature is properly determined taking the decomposition temperature of the pore-forming material into consideration.

Since a dielectric film formed by a method of embodiments of the present invention has a low dielectric constant and good mechanical properties, it may be useful as a semiconductor interlayer dielectric film.

Hereinafter, embodiments of the present invention will be described in more detail with reference to the following examples. However, these examples are given for the purpose of illustration and are not to be construed as limiting the scope of the invention.

[Evaluation of Physical Properties]

First, the performance of dielectric films formed in the following examples and comparative examples was evaluated in the following procedures.

1. Measurement of Thickness and Dielectric Constant:

First, a thermal silicon oxide film is coated to a thickness of 3,000 Å on a boron-doped p-type silicon wafer, and then a 100 Å thick titanium film, a 2,000 Å thick aluminum film and a 100 Å thick titanium film are sequentially deposited on the silicon oxide film using a metal evaporator. Thereafter, a dielectric film is coated on the resulting structure, after which a 100 Å thick circular titanium thin film (diameter: 1 mm) and a 5,000 Å thick aluminum thin film (diameter: 1 mm) are sequentially deposited on the dielectric film using a hardmask designed so as to have an electrode diameter of 1 mm, to form a low-dielectric constant thin film having a MIM (metal-insulator-metal) structure. The dielectric constant of the low-dielectric constant thin film is measured. The capacitance of the thin film is measured around 10 kHz, 100 kHz and 1 MHz using a PRECISION LCR METER (HP4284A) accompanied with a probe station (Micromanipulatior 6200 probe station). The thickness of the thin film is measured using a prism coupler. The dielectric constant (k) of the thin film is calculated according to the following equation:
k=C×d/εₒ×A

in which k is the relative permittivity, C is the capacitance, εₒ is the dielectric constant of a vacuum (8.8542×10⁻¹² Fm⁻¹), d is the thickness of the dielectric film, and A is the contact cross-sectional area of the electrode.

2. Modulus:

The modulus of a dielectric thin film is determined by quantitative analysis using a Nanoindenter II (MTS). Specifically, after the nanoindenter is indented into the thin film until the indentation depth reaches 10% of its overall thickness, the modulus of the thin film is measured. To ensure better reliability of the measurement in the following examples and comparative examples, the modulus were measured at a total of 9 indention points on the dielectric film, and the obtained values were averaged.

### SYNTHESIS EXAMPLE 1

### Synthesis of Compound A-1

10.00 g of trimethylsilyl terminated polymethyl hydrosiloxane (average molecular weight: −5,000, n is about 80) was diluted with 100 ml of tetrahydrofuran (THF) in a flask, and then 200 mg of 10 wt % palladium/charcoal (Pd/C) was added thereto. 177.8 mmol (3.20 ml) of distilled water was added to the mixture to evolve hydrogen gas. At this time, the hydrogen gas was removed. The reaction was allowed to proceed at room temperature for 15 hours. The reaction solution was filtered through celite and MgSO₄, and the obtained filtrate was concentrated at a pressure of about 0.1 torr to completely remove volatile materials, affording a silane compound (‘A-1’) of Formula 6 as a liquid.

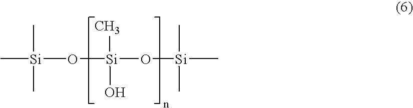

wherein n is an integer of about 80.

### SYNTHESIS EXAMPLE 2

### Synthesis of Compound A-2

A silane compound of Formula 6-1 was synthesized in the same manner as in Synthesis Example 1, except that 10.00 g of trimethylsilyl terminated polymethyl hydrosiloxane (average molecular weight: −390, n is about 4) was used.

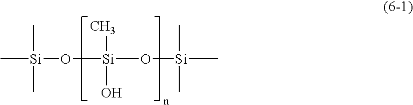

wherein n is 4.

### SYNTHESIS EXAMPLE 3

### Synthesis of Compound A-3

A silane compound of Formula 7 (‘A-3’) was synthesized in the same manner as in Synthesis Example 1, except that 180 mmol (7.3 ml) of methanol was used instead of 177.8 mmol (3.20 ml) of distilled water.

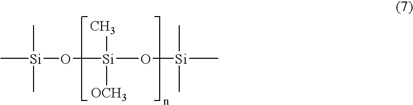

wherein n is an integer of about 80.

### SYNTHESIS EXAMPLE 4

### Synthesis of Compound A-4

After 9 g of tetramethoxysilane was diluted with 42 ml of tetrahydrofuran in a flask, the dilution was maintained at −78° C. 8.52 g of an aqueous hydrochloric acid solution (0.001 mol/ml) was added to the flask. The temperature of the reaction solution was gradually raised to 80° C. After the reaction solution was allowed to react for 3 hours, it was allowed to cool to room temperature to afford a solution of the compound of Formula 8 (‘A4’):
SiₐO_{0.5b}(OMe)_{c}(OH)_{d} (8)

wherein a is an integer of 2 to 500, 4a=(b+c+d).

### SYNTHESIS EXAMPLE 4-1

A solution of the compound of Formula 8 (‘A-4’) was synthesized in the same manner as in Synthesis Example 3, except that 4.5 g of tetramethoxysilane, 20 ml of tetrahydrofuran and 4.26 g of an aqueous hydrochloric acid solution (0.001 mol/ml) were used.

### SYNTHESIS EXAMPLE 5

### Synthesis of Compound B-1

41.6 mmol (10.00 g) of 2,4,6,8-tetramethyl-2,4,6,8-cyclotetrasiloxane was diluted with 100 ml of tetrahydrofuran in a flask, and then 200 mg of 10 wt % palladium/charcoal (Pd/C) was added thereto. Subsequently, 177.8 mmol (3.20 ml) of distilled water was added to the mixture to evolve hydrogen gas. At this time, the hydrogen gas was removed. The reaction was allowed to proceed at room temperature for 15 hours. The reaction solution was filtered through celite and MgSO₄, and the obtained filtrate was concentrated at a pressure of about 0.1 torr to completely remove volatile materials, affording a monomer (‘B-1’) of the following formula as a colorless liquid.

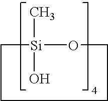

The analytical results of the ¹H NMR spectrum (300 MHz) of the monomer (in acetone-d₆ solution) are as follows: δ0.067 (s, 12H, 4×[—CH₃]), 5.52 (s, 4H, 4×[—OH]).

### SYNTHESIS EXAMPLE 6

### Synthesis of Compound B-2

41.6 mmol (12.6 g) of the liquid reaction product prepared in Synthesis Example 5 was diluted with 200 ml of tetrahydrofuran (THF), and then 177.8 mmol (13.83 g) of triethylamine was added thereto. The resulting solution was cooled to −0° C. After 177.8 mmol (25.0 g) of chlorotrimothxymethylsilane was slowly added to the solution, the temperature was gradually raised to room temperature. The reaction was allowed to proceed for 15 hours. The reaction solution was filtered through celite, and the obtained filtrate was concentrated at a pressure of about 0.1 torr to completely remove volatile materials, affording a monomer (‘B-2’) of the following formula as a colorless liquid.

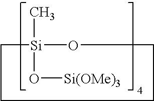

The analytical results of the ¹H NMR spectrum (300 MHz) of the monomer are as follows: δ0.092 (s, 12H, 4×[—CH₃]), 3.58 (s, 9H, 4×[—CH₃]).

### PREPARATIVE EXAMPLE 1

### Preparation of Polymer P-1

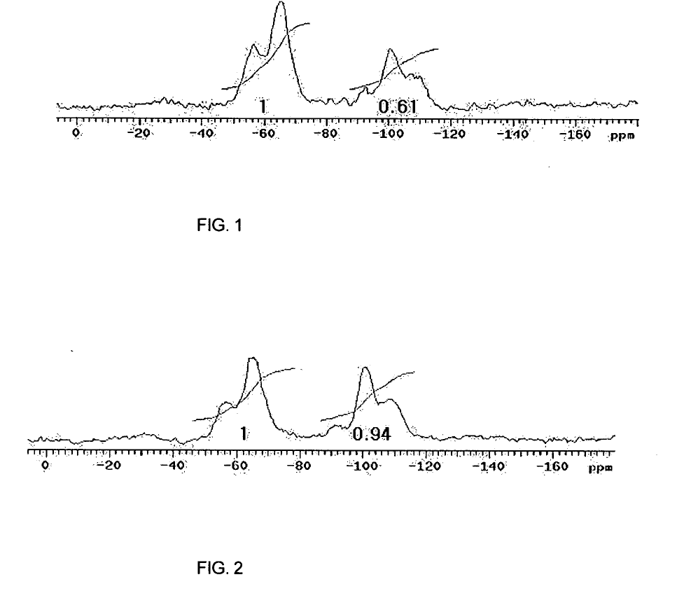

Compound A-1 prepared in Synthesis Example 1 was diluted with tetrahydrofuran to obtain a dilution (8.3 wt %). 36 ml of the dilution was reacted with 18.3 g of the solution of compound A-3 prepared in Synthesis Example 3 in a flask for 20 hours while the reaction solution was slowly heated from room temperature to 70° C. so that the molar ratio (Q/T) between ‘Q’ and ‘T’ structures became 0.5. The reaction solution was transferred to a separatory funnel, followed by the addition of diethyl ether in the same amount as that of the THF added initially and tetrahydrofuran. The resulting mixture was washed three times with water in the amount of one tenth of the total volume of the solvents used, and was then concentrated at reduced pressure to remove volatile materials, giving a polymer as a white powder. The polymer was dissolved in tetrahydrofuran until it became transparent, and filtered through a filter (pore size: 0.2 μm). Water was slowly added to the filtrate to obtain a precipitate as a white powder. The precipitate was dried at 0-20° C. and 0.1 torr for 10 hours to afford a siloxane polymer. The Si-NMR spectrum of the siloxane polymer is shown in FIG. 1.

### PREPARATIVE EXAMPLE 2

### Preparation of Polymer P-2

Compound A-1 prepared in Synthesis Example 1 was diluted with tetrahydrofuran to obtain a dilution (8.3 wt %). 30 ml of the dilution was reacted with 27.43 g of the solution of compound A-3 prepared in Synthesis Example 3 in a flask so that the molar ratio (Q/T) between ‘Q’ and ‘T’ structures became 0.9. Thereafter, polymer P-2 was prepared by the same procedure as in the preparation of polymer P-1. The Si-NMR spectrum of polymer P-2 is shown in FIG. 2.

### PREPARATIVE EXAMPLE 3

### Preparation of Polymers P-3-P6

Each of the multi-functional cyclic silicate compound prepared in Synthesis Example 6 and the siloxane compounds synthesized in Synthesis Examples 1 and 2 was placed in a flask in accordance with the amounts indicated in Table 1, followed by dilution with 50 ml of tetrahydrofuran. The solution was cooled to −78° C. To the solution was added an aqueous hydrochloric acid solution (0.001 mol/ml) in the amount indicated in Table 1. After the temperature of the solution was raised to 70° C., the reaction was allowed to proceed for 20 hours. The reaction solution was transferred to a separatory funnel, followed by the addition of diethyl ether in the same amount as that of the THF added initially and tetrahydrofuran. The resulting mixture was washed three times with water in the amount of one tenth of the total volume of the solvents used, and was then concentrated at reduced pressure to remove volatile materials, giving a polymer as a white powder. The polymer was dissolved in tetrahydrofuran until it became transparent, and filtered through a filter (pore size: 0.2 μm). Water was slowly added to the filtrate to obtain a precipitate as a white powder. The precipitate was dried at 0-20° C. and 0.1 torr for 10 hours to fractionate a siloxane polymer.

TABLE 1

| Polymer | B-2 (g) | A-1 (g) | A-2 (g) | aq. HCl (g) |
|---|---|---|---|---|
| P-3 | 5 | — | 0.242 | 2.1 |
| P-4 | 5 | 0.242 | — | 2.1 |
| P-5 | 3.5 | — | 1.358 | 1.5 |
| P-6 | 3.5 | 1.358 | — | 1.5 |

Formation of Dielectric Films A and A-1:

0.83 g of polymer P-1 alone was used as a siloxane-based polymer to form a non-porous dielectric film (dielectric film A). Polymer P-1 and 0.249 g of heptakis[2,3,6 tri-O-methyl]-β-cyclodextrin as a pore-forming material were used to form a porous dielectric film (dielectric film A-1).

Each of the polymers or the pore-forming material was dissolved in propylene glycol methyl ether acetate as a solvent to prepare a coating solution having a solid content of 25 wt %. The coating solution was spin-coated on a silicon wafer at 3,000 rpm for 30 seconds, pre-baked on a hot plate under a nitrogen atmosphere at 150° C. for one minute and at 250° C. for one minute, sequentially, and dried to form a film. The film was baked under vacuum while heating to 420° C. at a rate of 3 ° C./min. for one hour to form dielectric films A and A-1. The thickness, refractive index, dielectric constant, and modulus of the dielectric films were measured. The results are shown in Table 2 below.

Formation of Dielectric Films B and B-1:

Dielectric films B and B-1 were formed in the same manner as in the formation of dielectric films A and A-1, except that copolymer P-2 was used instead of polymer P-1. The thickness, refractive index, dielectric constant, and modulus of the dielectric films were measured. The results are shown in Table 2 below.

TABLE 2

| | Thickness | Refractive | Dielectric | Modulus |
|---|---|---|---|---|
| Dielectric Film | (Å) | index | constant | (GPa) |
| Dielectric film A | 8,703 | 1.3774 | 2.76 | 7.37 |
| Dielectric film A-1 | 7,036 | 1.2976 | 2.23 | 4.50 |
| Dielectric film B | 14,074 | 1.3810 | 3.01 | 9.40 |
| Dielectric film B-1 | 10,513 | 1.2850 | 2.56 | 4.03 |

It is obvious from the results of Table 2 that the dielectric constant increases with increasing amount of the ‘Q’ structure, but the thin films exhibit a high modulus without hygroscopicity even in a molar ratio (Q/T) of about 0.9. In addition, the dielectric constant decreases due to the presence of the pore-forming material, indicating that the polymers are highly miscible with the pore-forming material.

Formation of Dielectric Films C and C-1:

Dielectric films C and C-1 were formed in the same manner as in the formation of dielectric films A and A-1, except that copolymer P-3 was used instead of polymer P-1. The thickness, refractive index, dielectric constant, and modulus of the dielectric films were measured. The results are shown in Table 3 below.

Formation of Dielectric Films D and D-1:

Dielectric films D and D-1 were formed in the same manner as in the formation of dielectric films A and A-1, except that copolymer P-4 was used instead of polymer P-1. The thickness, refractive index, dielectric constant, and modulus of the dielectric films were measured. The results are shown in Table 3 below.

Formation of Dielectric Films E and E-1:

Dielectric films E and E-1 were formed in the same manner as in the formation of dielectric films A and A-1, except that copolymer P-5 was used instead of polymer P-1. The thickness, refractive index, dielectric constant, and modulus of the dielectric films were measured. The results are shown in Table 3 below.

TABLE 3

| | Thickness | Refractive | Dielectric | Modulus |
|---|---|---|---|---|
| Dielectric film | (Å) | index | constant | (GPa) |
| Dielectric film C | 8,479 | 1.3855 | 3.04 | 11.40 |
| Dielectric film C-1 | 8,948 | 1.3175 | 2.47 | 6.69 |
| Dielectric film D | 7,355 | 1.3829 | 3.01 | 11.34 |
| Dielectric film D-1 | 7,553 | 1.2856 | 2.42 | 4.90 |
| Dielectric film E | 6,953 | 1.3772 | 2.86 | 6.47 |
| Dielectric film E-1 | 7,469 | 1.3047 | 2.41 | 3.91 |

A thin film was not readily formed using copolymer P-6. As may be seen from the data shown in Table 3, considering the pore-forming material was added in the same amount, the films formed using compound A-1 having a relatively large molecular weight exhibit superior physical properties, including modulus and miscibility with the pore-forming material, to the films formed using compound A-2 having a relatively small molecular weight.

As apparent from the above description, a siloxane compound of embodiments of the present invention is highly reactive. In addition, a siloxane-based polymer prepared from a siloxane compound according to embodiments of the present invention not only has superior mechanical properties, thermal stability and crack resistance, but also exhibits low hygroscopicity and good compatibility with pore-forming materials, which leads to a low dielectric constant. Furthermore, a siloxane-based polymer of embodiments of the present invention retains a high SiO₂ content, resulting in improved applicability to semiconductor processes. Therefore, a siloxane-based polymer of embodiments of the present invention may be advantageously used as a material for dielectric films of semiconductor devices.

Although preferred embodiments of embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A siloxane-based polymer prepared by the hydrolysis and polycondensation of a monomer represented by Formula 1 below: 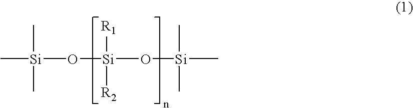
wherein R₁ and R₂ are each independently a hydrogen atom, hydroxy, alkoxy, acetoxy, alkyl, aryl, or O—Si(OR)₃ (in which R is a C₁-C₃ alkyl group); and n is an integer of 2 to 100 (with the proviso that at least one of R₁ and R₂ is a reactive functional group selected from a hydrogen atom, hydroxy, alkoxy, acetoxy, or O—Si(OR)₃),
with at least one monomer selected from compounds represented by Formulae 2 to 5 below:
(R₁)ₙSi(OR₂)₄₋ₙ (2)
wherein R₁ is a hydrogen atom, a C₁-C₃ alkyl group, a halogen atom, or a C₆-C₁₅ aryl group; R₂ is a hydrogen atom, a C₁-C₃ alkyl group or a C₆-C₁₅ aryl group, with the proviso that at least one of R₁ and OR₂ is a hydrolysable functional group; and n is an integer of 0 to 3, 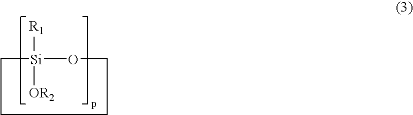
wherein R₁ is a hydrogen atom, a C₁-C₃ alkyl group or a C₆-C₁₅ aryl group; R₂ is a hydrogen atom, a C₁-C₁₀ alkyl group or SiX₁X₂X₃ (in which X₁, X₂ and X₃ are each independently a hydrogen atom, a C₁-C₃ alkyl group, a C₁-C₁₀ alkoxy group, or a halogen atom, with the proviso that at least one of X₁, X₂ and X₃ is a hydrolysable functional group); and p is an integer of 3 to 8, 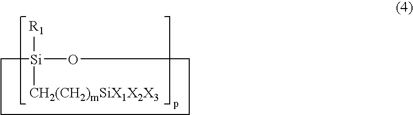
wherein R₁ is a hydrogen atom, a C₁-C₃ alkyl group or a C₆-C₁₅ aryl group; X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; m is an integer of 0 to 10; and p is an integer of 3 to 8,
X₃X₂X₁Si—M—SiX₁X₂X₃ (5)
wherein X₁, X₂ and X₃ are each independently a hydrogen atom, a C₁-C₃ alkyl group, a C₁-C₁₀ alkoxy group or a halogen atom, with the proviso that at least one of X₁, X₂ and X₃ is a hydrolysable functional group; M is a C₁-C₁₀ alkylene group or a C₆-C₁₅ arylene group, hydrolysates thereof, and condensates thereof,
in an organic solvent in the presence of water and an acid or base catalyst.

2. The siloxane-based polymer according to claim 1, wherein the acid catalyst is hydrochloric acid, nitric acid, benzene sulfonic acid, oxalic acid, formic acid, or a mixture thereof; and the base catalyst is potassium hydroxide, sodium hydroxide, triethylamine, sodium bicarbonate, pyridine, or a mixture thereof.

3. The siloxane-based polymer according to claim 1, wherein a molar ratio of the total monomers to the acid or base catalyst is in the range of 1:1×10⁻⁵ to 1:10.

4. The siloxane-based polymer according to claim 1, wherein a molar ratio of the total monomers to water is in the range of 1:1 to 1:100.

5. The siloxane-based polymer according to claim 1, wherein the hydrolysis and the polycondensation are carried out at 0-200° C. for 0.1-100 hours.

6. The siloxane-based polymer according to claim 1, wherein the organic solvent is an aliphatic hydrocarbon solvent selected from hexane and heptane; an aromatic hydrocarbon solvent selected from anisole, mesitylene and xylene; a ketone-based solvent selected from methyl isobutyl ketone, 1-methyl-2-pyrrolidinone, cyclohexanone and acetone; an ether-based solvent selected from tetrahydrofuran, isopropyl ether and propylene glycol propyl ether; an acetate-based solvent selected from ethyl acetate, butyl acetate and propylene glycol methyl ether acetate; an alcohol-based solvent selected from isopropyl alcohol and butyl alcohol; an amide-based solvent selected from dimethylacetamide and dimethylformamide; a silicon-based solvent; or a mixture thereof.

7. The siloxane-based polymer according to claim 1, wherein the siloxane-based polymer has a weight average molecular weight of 3,000 to 300,000.

8. A method for forming a dielectric film comprising the steps of
i) dissolving the siloxane-based polymer according to claim 1 and, optionally, a pore-forming material in an organic solvent to prepare a coating solution, and
ii) applying the coating solution to a substrate, followed by heat-curing.

9. The method according to claim 8, wherein the pore-forming material is selected from cyclodextrins, polycaprolactones, Brij surfactants, polyethylene glycol-polypropylene glycol-polyethylene glycol triblock copolymer surfactants, and derivatives thereof.

10. The method according to claim 8, wherein the pore-forming material is used in an amount of 1% to 70% by weight, based on the total weight of the solid matters of the coating solution.

11. The method according to claim 8, wherein the organic solvent is an aliphatic hydrocarbon solvent selected from hexane and heptane; an aromatic hydrocarbon solvent selected from anisole, mesitylene and xylene; a ketone-based solvent selected from methyl isobutyl ketone, 1 -methyl-2-pyrrolidinone, cyclohexanone and acetone; an ether-based solvent selected from tetrahydrofuran, isopropyl ether and propylene glycol propyl ether; an acetate-based solvent selected from ethyl acetate, butyl acetate and propylene glycol methyl ether acetate; an alcohol-based solvent selected from isopropyl alcohol and butyl alcohol; an amide-based solvent selected from dimethylacetamide and dimethylformamide; a silicon-based solvent; or a mixture thereof.

12. The method according to claim 8, wherein the coating solution has a solid content of 5-70% by weight, based on the total weight of the coating solution.

13. The method according to claim 8, wherein, in step ii), the heat curing is performed at 150-600° C. for 1-180 minutes.

14. A dielectric film formed by the method according to claim 8.

15. A semiconductor device comprising a dielectric film formed by the method according to claim 8.
